(19) United States
(12) Patent Application Publication
(10) Pub. No.: US 2004/0160123 A1
(43) Pub. Date: Aug. 19, 2004

(54) Combined four way and seven way connector assembly for use with a vehicle and for accommodating a trailer tow package and which in particular incorporates circuit protection and power switching capability

(76) Inventors: Robert C. Burdick, Romulus, MI (US); Robert S. Migrin, Livonia, MI (US)

Correspondence Address: ECKERT SEAMANS CHERIN & MELLOTT, LLC, ALCOA TECHNICAL CENTER, 100 TECHNICAL DRIVE, ALCOA CENTER, PA, 15069-0001, US

(21) Appl. No.: 10/649,913

(22) Filed: Aug. 26, 2003

Related U.S. Application Data
(63) Continuation-in-part of application No. 09/862,213, filed on May 23, 2001, now Pat. No. 6,642,628.

(51) Int. Cl. H02G 3/00

(52) U.S. Cl. 307/10.1

(57) ABSTRACT

A connector assembly for use with either a four or seven way vehicle input harness. A housing is secured to a rear end location of the vehicle. A circuit board is secured within the housing. A first plurality of terminals defines the four way connector and a second plurality of terminals defines the seven way connector. Each of the terminals communicates with selected circuits and further defines input plugs accessible through the housing by the towed vehicle input harness. An electrical supply of the vehicle is engaged through the housing in order to electrically communicate the towing vehicle's electrical supply. A magnetically switching transistor operates, in combination with a magnet, to enable or disable power to each of the connectors based upon the positioning of an access cover associated with the connectors and indicative of the presence of a wire engaging harness.

### CROSS REFERENCE TO RELATED APPLICATIONS

The present application is a continuation-in-part of U.S. patent application Ser. No. 09/862,213, filed May 23, 2001, and entitled “A Combined Four Way and Seven Way Connector Assembly for Use With a Vehicle and for Accommodating a Trailer Tow Package”.

### FIELD OF THE INVENTION

The present invention relates generally to four and seven way connector assemblies for communicating a vehicle's electrical system with corresponding four or seven way input connectors extending from conventional trailer tow packages. More particularly, the present invention is directed to a single unit assembly which combines both the seven and four way fret connectors, the combined assembly capable of being secured at an appropriate location on the rear of the vehicle or near the point a trailer harness would connect to the tow vehicle.

The improved connector assembly further includes such features as circuit sensor protection in the form of a magnetically switched output to the vehicle and in order to instruct the vehicle to selectively disable or enable power to the four way and seven way connector portions. Additionally, back up aid sensors (BUAS) are provided and which warn the driver of objects in the path of the vehicle when it is in reverse. The back up sensors are connected, via the trailer tow assembly module, to the vehicle and as opposed to being connected through a separate wire harness.

### BACKGROUND OF THE INVENTION

The towing of work and recreational trailers and campers, behind a vehicle, is well known in the art. For reasons of safety and convenience, it is necessary to communicate the towing vehicle's electrical supply system to electrically operable accessories located on the wheeled trailer or camper being towed. The number of such accessories typically range from the rear lights of a trailer, usually requiring up to four electrical circuits to up to several electrical accessories, including again rear lights and additional refrigeration, heating, and/or power supply requirements typical of tow-behind campers.

The existence of four way and seven way fret connectors, these being the power supply terminals to which the power input cords of the trailer or RV plugs into, are by themselves known in the art. The prior art contemplates the seven way and four way connectors being separately connected to the vehicle's electrical system and extending, in substantially freely hanging fashion, from the vehicle's rear bumper. The prior art also includes the provision of a separately engageable adapter and which, depending upon which input side is engaged, adapts an output side to either a four way or seven way connector. Additionally, power switching functions for various trailer/RV options are further accomplished through components packaged inside the vehicle or under the hood. Among the disadvantages attendant with having separate four and seven way connectors at the rear of the vehicle is the requirement that the both such connectors must always be made available in the event a customer requests a trailer tow option on the vehicle.

Additional examples of prior art connectors including the unified connector interface, U.S. Pat. No. 5,443,389 issued to Hughes. The connector interface mounts on a towing vehicle and is adapted to provide electrical connection with any one of a plurality of towed vehicle wiring harness electrical connectors. The unified connector interface is adapted to receive a selected round connector having a plurality of connectors extending from the towed vehicle wiring harness. The unified connector interface is also adapted to provide an interface between complimentary connectors and with piggyback double electrical connectors, as well as with individual or two wire connectors. The housing of the device is further sized to receive a circuit board therein, which aligns the connectors on the first side with the connectors on the second side.

U.S. Pat. No. 5,354,204, issued to Hughes, teaches a wiring harness adapter and method for fabricating in which the adapting has particular application for mating a four-way flat harness connector of a trailer at one end and a complex round harness connector with numerous terminals at an opposite end. U.S. Pat. No. 5,514,009, also issued to Hughes, teaches another variation of a wire harness adaptor and method for connecting the vehicle electrical system to the tow vehicle and in particular to a four way flat harness connector.

U.S. Pat. No. 5,765,848, issued to Silvey, discloses a trailer accessory for protectably receiving trailer plugs and in which a boot having one or more plug receptacles is connected to the tongue of a trailer as well as for holding the trailer chains. The boot is constructed of a pliable thermoplastic rubber elastomer with form fitted plug receptacles for receiving the trailer plugs, for such as lighting and braking the trailer. A base of the unit includes a central aperture for creating an interference fit with the boot and outboard slots for receiving the ends of trailer chains and the base is further connected to the tongue of the trailer by threaded fasteners.

Finally, U.S. Pat. No. 5,719,552, issued to Thompson, illustrates a system and method for illuminating an area proximate a trailer, and such as further a boat or snowmobile trailer. According to Thompson, at least one area illuminating light is connected to an area illuminating lighting control member and which receives and interprets trailer lighting control signals for determining when to activate or deactivate the area illuminating light.

Control signals include a trailer tow vehicle “lights on” condition combined with a second trailer lighting control signal, such as a “reverse lights on” indication from a water sensor or manual switch. The area illuminating lighting control member also receives a set of trailer lighting control signals for automatically deactivating the trailer illuminating lighting, including a “running light off” indication, a “brake lights on” indication, and/or a “turn signal lights on” indication. The trailer may further include trailer lighting, which may optionally be deactivated by a disabling signal from the area illuminating lighting control member based on input from a sensor such as a water sensor.

### SUMMARY OF THE INVENTION

The present invention discloses an integral housing combining both seven way and four way fret connectors into a single unit, the combined assembly capable of being secured at an appropriate location, such as to the rear bumper of the vehicle, and of providing effective communication of a towing vehicle's electrical supply to an input harness associated with a tow behind vehicle, such as again may include a trailer, recreational vehicle or the like. The present invention is further an improvement over the prior art in that it does away with the need for separate seven and four way connectors, as well as the use of adapters, in favor of a single housing construction displaying both the four and seven way connector inputs in proximate and engageable fashion. The present invention further enables the use of light gauge signal wires extending from the vehicle to the unit housing and provides high current switching content from congested areas of the vehicle electrical system to areas without congestion.

The housing for the connector assembly may be provided as a single piece or, alternatively, as first and second assembleable portions. The housing includes a top and a plurality, typically four, interconnected sides which defines a three dimensional module.

A plurality of circuits are contained within the housing and are incorporated, in one variant, into a circuit board which communicates with pluralities of four and seven terminals which define, respectively, the four and seven way connectors. Typically, a total of seven circuits are provided, for accommodating the requirements of the seven way connector, and a subset four of these circuits are shared with the four way connector.

Additional pluralities of electrical components, including fuses, electromechanical relays and the like, are secured to the circuit board and provide circuit protection and power switching functions to the module. Alternatively, these components may be incorporated into the vehicles existing electrical system and the combined four and seven way module limited to the basic circuit arrangement and terminal pluralities.

The terminals of the first variant include the provision of metal frets which are soldered by solder tails upon a selected face of the circuit board and interiorly configured receiving holes are further defined within the frets for facilitating the subsequent engagement by the towed input harness. An insulator layer is typically provided between the metal frets and the circuit board and acts as a spacer as well as to mechanically isolate the fret solder tails from the circuit board solder joints. Access covers corresponding to each of the seven and four way connectors are defined upon the housing and are actuable to reveal the pluralities of terminals, or frets, corresponding to the individual connectors.

A further variant discloses the application of the printed circuit board for establishing all of the electrical connections between the terminals and without the provision of the metal frets. A potting material encapsulates the printed circuit and in order to relieve component mechanical strain.

A yet further variant discloses the circuit board substituted by an insert molded components integrating metal stampings and a plasticized insulator and which also provides the mechanical features for terminal strain relief and electrical conduction. A still further variation teaches the use of a flexible circuit integrating an electrically conductive foil and plastic insulating laminate and to which the components are soldered. A potting material again may be utilized to encapsulate the components associated with the flexible circuit and to provide mechanical strain relief.

A further embodiment of the present invention contemplates an improved connector assembly incorporating such features as “intelligent” circuit sensor protection. The intelligent trailer tow module includes magnetically switched output (otherwise known as a “hall effect device”) in order to selectively instruct the vehicle to disable or enable power to the four way and seven way connector portions.

The hall effect device operates by changing its output state when a magnetic force passes through it. In the preferred embodiment, a magnet is attached to a lip of the module cover and, in the closed position, sends a signal to the vehicle to disable the power from the vehicle to the module. Upon being rotated to the open position, and maintained in that position by virtue of a connector plugged into either or both the four way and seven way connectors, the hall effect device is maintained in a “trailer on” state, thus sending a signal to the vehicle resulting in the flow of power to the trailer tow module. Additional sub-variants of the intelligent trailer tow module includes alternate configurations of the cover which apply to only the main seven way connector or, alternatively, may be configured to also include a cover portion associated with the four way connector.

The trailer tow module may also include back up aid sensors (BUAS) which warn the driver of objects in the path of the vehicle when it is in reverse. The back up sensors are connected, via the trailer tow assembly module, to the vehicle and as opposed to being connected through a separate wire harness.

Other and additional features include the incorporation of all the rear lighting functions associated with the vehicle, as well as the incorporation of a multiplex node in order to reduce the number of signal wires required between the vehicle and the trailer tow module. Yet additional features include the provision of rear video and weather sensing devices which further operate to monitor temperature and humidity to warn the driver of potential icy road conditions.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is an environmental view of the combined four way and seven way connector assembly mounted to the rear of a towing vehicle;

FIG. 2 is an assembled and rotated view, in perspective, of the connector assembly also shown in FIG. 1;

FIG. 2a is an exploded view of a connector assembly according to FIG. 2 and illustrating the stamped frets, insulator, assembleable housing portions and four and seven way access covers along with the provision of integral input connector engageable with the connector assembly housing and for communicating the towing vehicle's electrical supply;

FIG. 2b is an enlarged view, taken along section line 2B of FIG. 2, and illustrating the metal frets for the combined four way and seven way connectors, as well as solder tails which mate and are soldered to the printed circuit board underlying the frets;

FIG. 3 is an exploded view of a first alternate embodiment of the combined four and seven way fret connector assembly of the present invention and which includes an insert molded component integrating the metal stampings and a plastic insulator;

FIG. 4 is an exploded view of a second alternate embodiment of the present invention and which includes a printed circuit board in substitution of the metal frets;

FIG. 5a is an exploded view of a third alternate embodiment of the present invention and which includes a flexible circuit integrating an electrically conductive foil and plastic insulator in substitution of the printed circuit board;

FIG. 5b is a further sectional view, in exploded fashion, of the flexible circuit illustrated in FIG. 5a and also showing the four and seven way blades, circuit protection components and mechanical relays according to the third alternate embodiment;

FIG. 6 is a perspective illustration of an intelligent trailer tow module according to a further preferred embodiment of the present invention;

FIG. 7 is a yet further variant of the intelligent trailer tow module and which incorporates a revised cover adapted to both the seven way and four way connector portions;

FIG. 8 is a schematic illustration of the magnetically switched transistor (hall effect device) in association with the seven way and four way connector portions and for selectively enabling or disabling power to the individual connector portions;

FIG. 9 is an end view of the pin connections associated with the four way connector portion; and

FIG. 10 is an end view of the pin connections associated with the seven way connector portion.

### DETAILED DESCRIPTION OF PREFERRED EMBODIMENTS

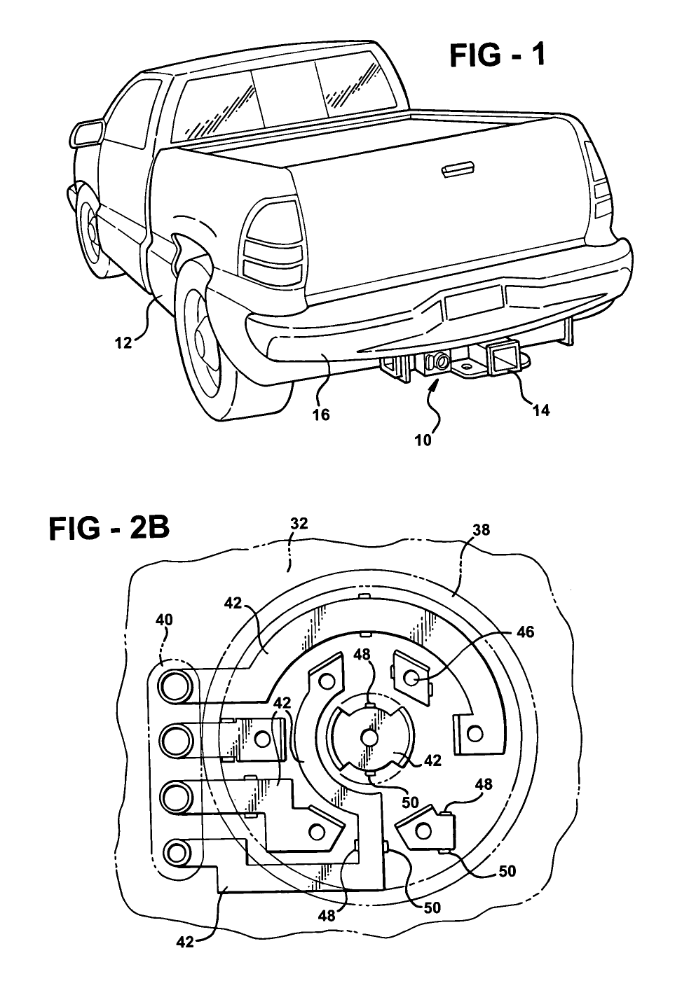

Referring now to FIG. 1, a combined four way and seven way connector assembly is illustrated at 10 for use with a towing vehicle 12 and for communicating the vehicle's existing electrical supply system to selected electrically operable devices associated with a tow-behind vehicle, such as typically including a trailer, recreational vehicle or the like. As previously described, the number of accessories associated with such tow behind vehicles (not shown) typically range from rear lights of a trailer (or RV), usually requiring up to four connectors. Additional electrical accessories, including again rear lights, electric brake and 12-volt battery charger (adding up to several accessories) are typical of tow-behind campers and to which the seven way connector is applicable. Further, and in a preferred application, the connector assembly 10 is secured to a location at the rear of the vehicle, such as in proximity to a trailer hitch 14 and beneath a rear bumper 16 of the vehicle 12. Some applications include locations in the box area of pickup trucks.

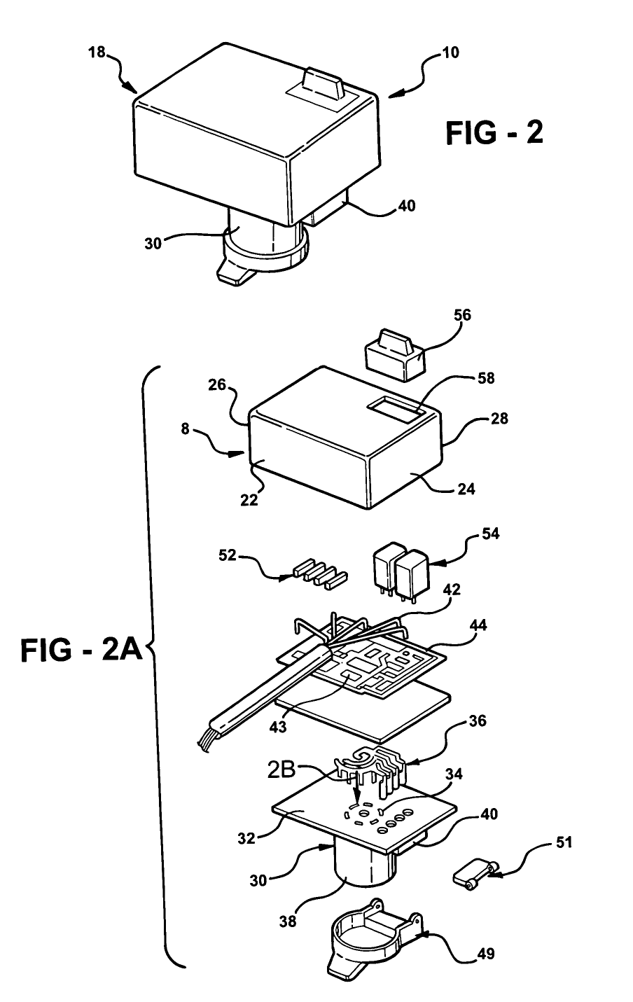

Referring now to FIG. 2, as well as to FIGS. 2A and 2B, the connector assembly 10 is again shown, a housing for which includes a first body portion 18 having a top 20 and first 22, second 24, third 26 and fourth 28 interconnected and extending sides which defines an interiorly hollowed (not shown) interior. A second assembly portion 30 of the housing is also provided as a three-dimensional article and includes a substantially flattened and planar shaped portion 32 which is matingly engageable around the interconnected perimeter defined by the sides 22-28 of the first body portion 18. The planar shaped portion 32 has defined, through its surface, an interior aperture array 34 for mating reception of a plurality of terminals 36 and which combines the four way and seven way connectors into one insert. In order to accommodate the insertion of the terminal array 36, the configuration of the second assembly portion 30 is deepened at 38 and 40 to seatingly receive the seven way and four way portions of the array 36, respectively and through the aperture array 34 and so that, referring again to FIG. 2B, respective four way and seven way receiving sockets are defined for receiving an associated input harness of the vehicle being towed.

According to the preferred variant, a circuit board arrangement is defined by a plurality of stamped metal frets 42, arranged according to a desired layout, and which are placed upon a circuit board surface defined also by an insulating layer 44 interposing between the frets and circuit board. A plurality of apertures 43 are defined through the insulating layer 44, at selected locations, and electrically communicate the stamped frets 42 with the four and seven way pins associated with the array 36.

Referring further to the enlarged section view of FIG. 2B, segmented portions of the fret array 42 are again illustrated and each of which terminates in interiorly configured receiving holes 46 (typically formed through the fret and underlaying circuit board and insulating layer) associated with both the first and second plurality components of the combined terminal array 36 and for receiving plastic posts (not shown) for relieving strain and for locating and communicating with the four and seven way terminal array 36. Also associated with each of the frets are individual pairs of extending solder tails (see at 48 and 50 by example in FIG. 2B) and which is soldered to the circuit board solder joints (while at the same time being mechanically insulated by surface insulating layer 44) to secure the frets in aligning fashion with the various terminals 36. Access covers 49 and 51 are also indicated, are secured to exposed end faces of the deepened portions 38 and 40 of the second assembly portion 30, and are actuable, respectively, to reveal the inputs associated with the seven way and the four way connectors.

Referring again to FIG. 2A, additional features of the variant 10 include the provision of fuses 52 and mechanical relays 54 which provide such features as circuit protection and power switching functions to the connector assembly. It is further understood that the necessary components identified at 52 and 54 can be removed from the connector assembly 10 within the scope of the present invention and that these functions may also be provided as a component of the towing vehicle's 12 existing electrical support and supply.

An input connector 56 is integrally formed with the housing and typically is positioned over the area on the top surface 20 of the first body component 18 and which is defined by the phantom area illustration 58. The input connector 56 communicates the towing vehicle's electrical supply to the circuits contained in the fret 42 and insulated circuit board 44 and consequently to the terminals 36 forming the seven and four way connectors.

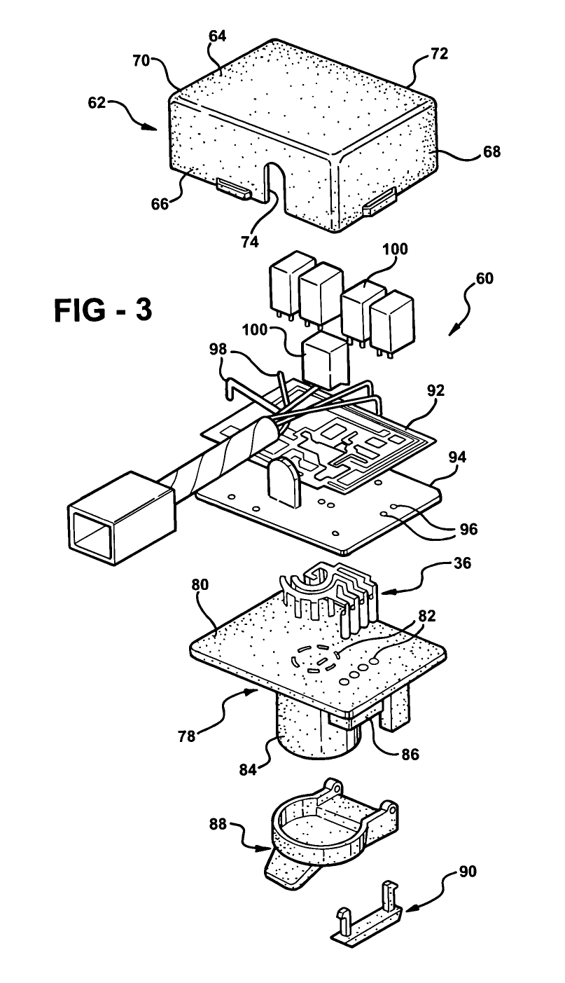

Referring now to FIG. 3, an exploded assembly is illustrated at 60 of the combined four and seven way connector assembly according to a further preferred variant and which includes a number of features consistent with the description of FIG. 2A, among those including a housing for which includes a first body portion 62 having a top 64 and first 66, second 68, third 70 and fourth 72 interconnected and extending sides which defines an interiorly hollowed (not shown) interior. A channeled recess 74 is defined in a selected side of the first body portion 62, such as first side 66 illustrated, and for purposes of receiving an input conduit 76 forming a portion of the electrical supply output of the towing vehicle.

A second assembly portion 78 of the housing is also provided as a three-dimensional article, substantially identical to that previously illustrated at 30 in FIG. 2A, and again includes a substantially flattened and planar shaped portion 80 which is matingly engageable around the interconnected perimeter defined by the sides 66-70 of the first body portion 62. As in the first variant, the planar shaped portion 80 has defined, through its surface, an interior aperture array 82 (defining apertures for both the four and seven way terminal pins) for mating reception of the plurality of terminals, again illustrated at 36, and which combines the four way and seven way connectors into one insert.

In order to accommodate the insertion of the terminal array 36, the configuration of the second assembly portion 78 is deepened at 84 and 86 to seatingly receive the seven way and four way portions of the array 36, respectively and through the aperture array 34 and so that respective four way and seven way receiving sockets are defined for receiving an associated input harness of the vehicle being towed. Access covers are again defined at 88 and 90 for covering, respectively the exposed end faces associated with the deepened body portions 84 and 86 and are actuable to reveal the terminals, associated with the insert array 36, and which correspond to the seven way and four way components.

According to the further preferred variant of FIG. 3, the circuit board arrangement is defined by an insert molded component 92 integrating metal stampings and a plasticized insulator and which replaces the plurality of stamped metal frets previously illustrated at 42 in the initial preferred embodiment of FIG. 2A. The insert molded component 92 is arranged according to a desired layout, and is placed upon an insulator 94 defining a mechanical barrier between the insert molded component 92 and the terminal array 36. A plurality of apertures 96 are defined through the insulating layer 94, at selected locations similarly as is defined by the apertures 43 in the insulating layer 44 in the first preferred variant, and communicate the circuits defined in the insert molded component 92 to specific terminals in the array 36 and which are associated with the four and seven way connectors.

Additional features of the variant 60 of the combined four and seven way connector assembly include individual lead wires 98 extending from the input conduit 78 and which in combination define a short wire harness which replaces the integrally formed input connector 56 in the first variant. The wires 98 communicate with selected locations upon the insert molded component 92 and thereby supply the electrical input of the towing vehicle.

Additional circuit and/or switching capacity may be provided to the connector assembly 60, illustrated such as by relays (five of which are shown) are illustrated collectively at 100 and which provide electromechanical or electrical power switching to the assembly. Alternatively, and as has been previously described, the present invention may function solely with the electrical circuits (embodied in some fashion), the terminal pin array 36 and a housing (having one or more pieces), the features of the switching and circuit protection being incorporated (if desired) directly into the existing electrical architecture of the towing vehicle.

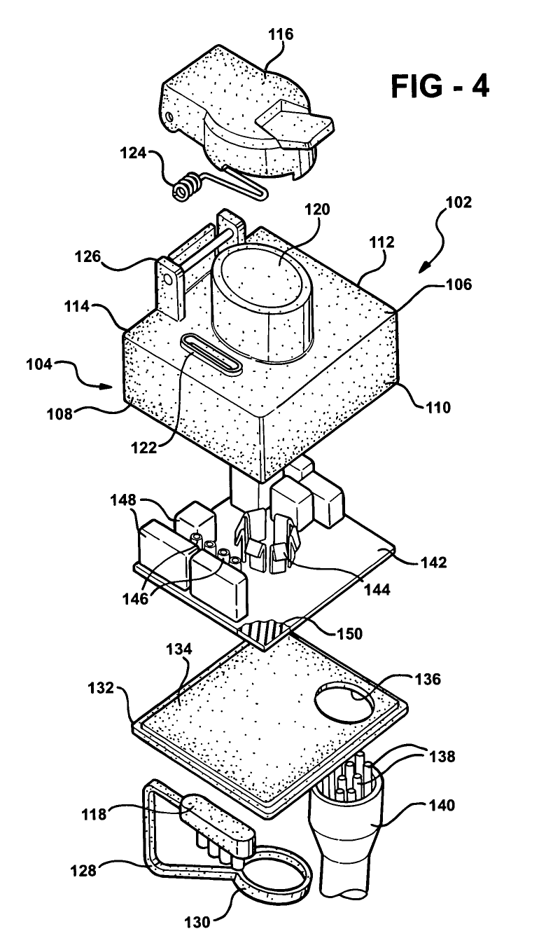

Referring now to FIG. 4, a further variant of the combined four and seven way connector assembly is illustrated in exploded fashion at 102. A housing further includes a first body portion 104 having a top 106 and four interconnected sides 108, 110, 112 and 114. First 116 and second 118 access covers associate with specified locations 120 and 122 defined, respectively, upon the exterior and exposed top 106 of the body portion 104. The locations 120 and 122 again correspond to insert sockets associated with the seven and four way connector terminals, as will be further described, and the access covers 120 and 122 are designed (the first access location 120 defining a projecting annular member and the second location 122 defining a recessed location) to be actuable to reveal the associated terminals.

The first access cover 116 is spring loaded at 124 and, upon being mounted to extending pedestal 126 associated with the top surface 106 of the body portion 104, spring loads the first cover 116 over the opening location 120. The second access cover 118 further includes an elongate and neck connecting portion 128 extending between the access cover 118 and a base ring 130, the ring 130 in turn affixing over the annular exterior surface defining the projecting location 120 associated with the seven way terminal array and to fixedly engage the second access cover to the assembly.

A second and backing portion of the housing is illustrated at 132 and includes an insulated top surface 134. The backing portion 132 is substantially rectangular shaped, in the preferred variant, and so as to matingly engaging against the open facing end of the first body portion 104. An annular and inwardly facing wall 136 is defined in the second backing portion 132 and defines an aperture for receiving a plurality of input wires 138 associated with the vehicle electrical supply, again illustrated in the form of a short wire harness 140 extending from the towing vehicles electrical supply system.

The plurality of circuits in the further preferred variant 102 of the present invention is provided by a printed circuit board 142 (and which again substitutes the use of metal frets such as in the preferred variant). First 144 and second 146 pluralities of terminals (again corresponding to the seven way and four way connector arrays, respectively) extend integrally from selected locations and from the selected and upper face of the printed circuit board 142. Extending ends of the input wires 138 engage at selected locations, not shown, preferably on the underside of the circuit board 142 and which associated with solder points of the first 144 and second 146 terminals of the seven and four way connectors. Circuit protection and switching capabilities may again be provided by such conventional components, generally referenced at 146, and the printed circuit board and components (including terminals 144 and 146 and components 148) may also be encapsulated in a potting material, referenced generally at 150, to provide component mechanical strain relief.

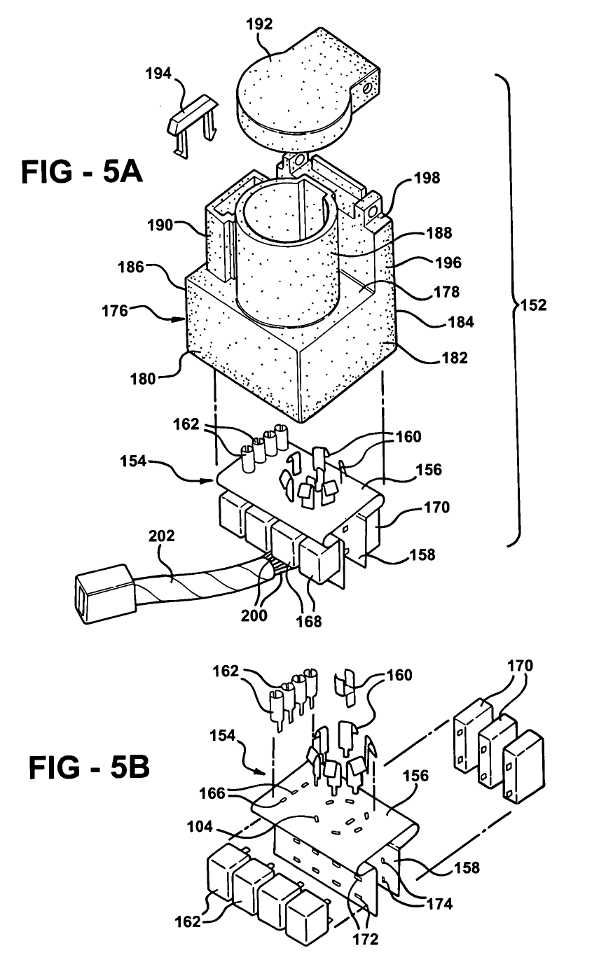

Referring finally to FIG. 5A, a combined four way and seven way connector assembly is illustrated at 152 according to a yet further variation of the present invention and which includes the plurality of electrical circuits embodied in a flexible circuit 154. The flexible circuit 154 is, by itself, a known element and integrates the features of an electrically conductive foil and a plastic insulating laminate. The flexible circuit 154 further includes a first face 156 and a second opposite face 158.

As best illustrated in the exploded view of FIG. 5B, the circuit 154 is capable of being configured in a desired fashion and so that the first face 156 defines a first location to which are secured first 160 and second 162 pluralities of terminals associated with the seven and four way connectors, respectively. Pluralities of apertures are defined in the flexible circuit 154, at 164 and 166, respectively, and for receiving in inserting fashion the seven way terminals 160 and the four way terminals 162.

Additional circuit protection components and relays, illustrated generally by pluralities of components 168 and 170 are secured to additional and folded side locations of the flexible circuit 154 defined along the first face 156. Additional pluralities of apertures 172 and 174 may be formed through the flexible circuit 154, along the side folded locations corresponding to the placement of the plurality of components 168 and 170. The various pluralities of apertures 164, 166, 172 and 174 therefore provide the ability to solder, or attach in any other suitable fashion, the terminals 160 and 162, as well as components 168 and 170, to the flexible circuit 154. As with the earlier preferred variant of FIG. 4, component strain relief may again be provided by encapsulating the components in a potting material and such as has been previously illustrated at 150 (again in FIG. 4).

Referring again to FIG. 5A, a housing includes a body portion 176 having a top 178 and four 180, 182, 184 and 186 interconnected sides. The body portion 176 is again configured in three dimension to enclose the flexible circuit 154, with assembled terminals 160, 162 and ancillary components 168 and 170. Defined in the top 178 of the body portion 176 are first 188 and second 190 projections and which define internal receiving cavities for the associated seven way terminals 160 and four way terminals 162. Although a second and covering body portion is not illustrated in FIG. 5A, it is understood that it advantageously may exist for enclosing the assembly. Alternatively, that the flexible circuit 154 can suitably be secured with the interior of the body portion 176 with or without the provision of an additional housing portion.

The first projection 188 is, similarly to the previously disclosed variants, an annular extending wall. The second projection 190 is likewise generally rectangular shaped and each projection 188 and 190 is configured to define an appropriate insertion socket aligning with the array of the selected plurality of terminals 160 and 162 and receiving the input plug associated with the existing wire supply harness (again not shown) of the towed vehicle.

First 192 and second 194 access covers again are associatingly engaged over the open ends corresponding to the first 188 and second 190 projections. A pedestal 196 (similar to that also illustrated at 126 in the variant of FIG. 4) can extend upwardly from the top 178 of the body portion 176 and to actually and pivotally engage, about an axis defined by 198 at the top of the pedestal 196, the access cover 192 for the seven way connector.

A plurality of input wires 200, associated again with a vehicle electrical supply harness 202, engage selected locations along the second opposite face 158 of the flexible circuit 154, and communicate with the terminals 160 and 162 and ancillary components 168 and 170 via the apertures 164, 166, 172 and 174, respectively, defined through the flexible circuit 154.

As previously explained, the present invention is an improvement over the prior art in that it does away with the need for separate seven and four way connectors, as well as the use of adapters, in favor of a single housing construction displaying both the four and seven way connector inputs in proximate and engageable fashion. The present invention further enables the use of light gauge signal wires extending from the vehicle to the unit housing and provides high current switching content from congested areas of the vehicle electrical system to areas without congestion.

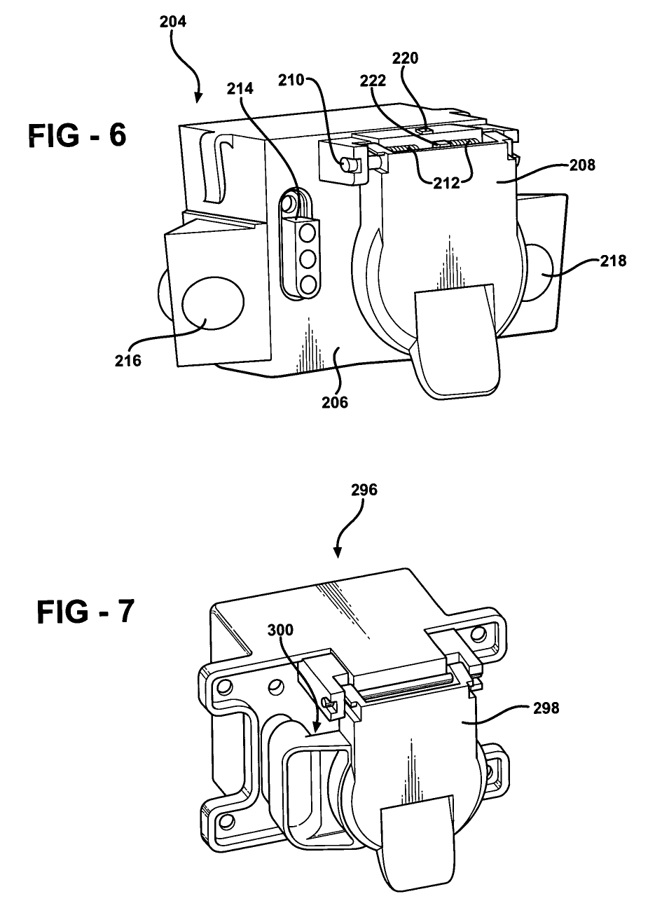

Referring now to FIG. 6, perspective illustration is shown at 204 of an intelligent trailer tow module according to a further preferred embodiment of the present invention. The intelligent module 204 repeats substantially the functions previously described in reference to the embodiment of FIGS. 1-5B and is further intended to greatly increase the life of the module terminals in the four and seven way connectors by virtue of disabling the electrical circuit within the module, in the absence of a connector established with either or both the four or seven way connectors, and thereby to eliminate the incidence of electrolysis caused by moisture on the terminals.

Consistent with the previous embodiment discuss, the intelligent trailer tow module 204 includes a rectangular shaped and three dimensional main body 206. An access cover 208 is pivotally associated about the seven way connector (hidden from view in this illustration) and about a pivot point 210 established with a front face of the 206 about a pin 210 and biased in a closed position by one or more springs 212; a four way connector further being illustrated at 214.

The intelligent trailer tow module 204 further incorporates, at 216 and 218, a pair of integrated back up aids in the form of back up assist sensors (BUAS). The purpose of the back up assist sensors is to warn the driver of objects in the path of the vehicle 12 when the vehicle is in reverse gear and is further disabled automatically upon a trailer being attached to the vehicle. Although not specifically illustrated, it is understood that the back up sensors 216 and 218 are connected to a suitable and audio/visual alarm device proximate in location to the passenger compartment of the vehicle 12 and in order to be audible to the driver.

Referring again to FIG. 6 a magnetically switched transistor is illustrated at 220, positioned proximate the top pivoting edge of the access cover 208 and in proximity to the pivot point 210. A magnet 222 is attached to the lip of the cover 208, a spaced location from the magnetically switched transistor 220 (also known as a Hall Effect Device) and in combination operates to selectively enable or disable power to and from the seven way and four way connectors.

In operation, the magnet 222 is spatially displaced (rotated) a given distance from the transistor (hall effect device) 220 upon the access cover 208 being pivoted to the opened position (which is further typically evidenced by the attachment of a plug, not shown, with the seven way connector and which holds open the spring biased access cover). The transistor (hall effect device) 220 changes output states when a magnetic force passes through it and, as long as a plug (not shown) is attached to the connector, the cover 208 will remain open thus keeping the transistor 220 in the “trailer on” state.

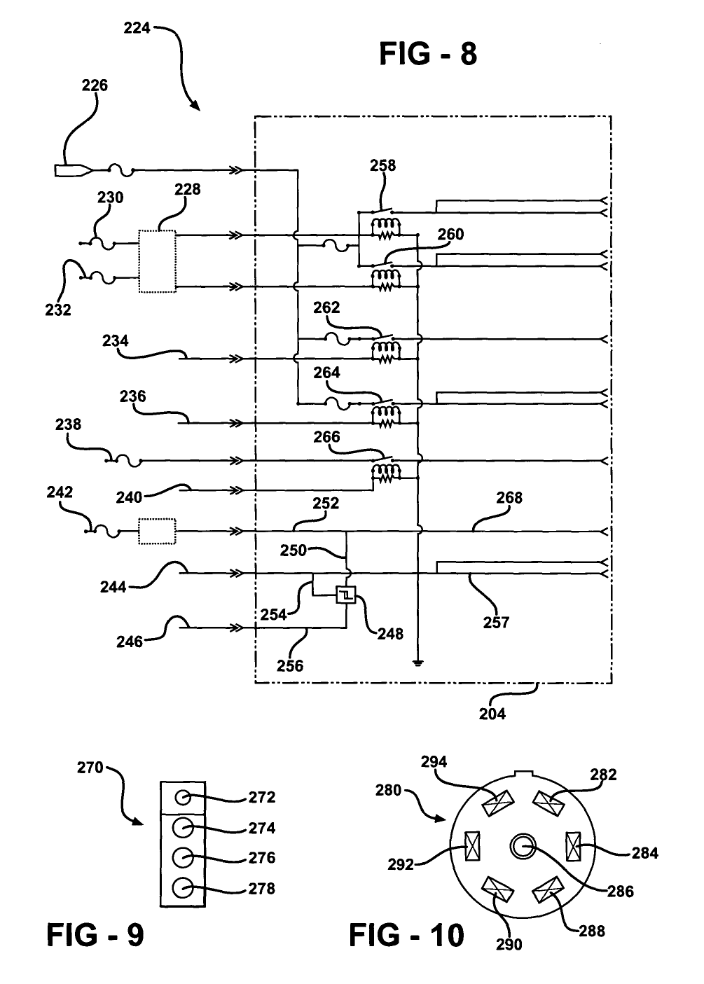

Referring further to FIG. 8, a schematic illustration is shown generally at 224 of the magnetically switched transistor (hall effect device) in association with the remaining electrical components associated with the trailer tow module and its seven way and four way connector portions. An outline of the module 204 is again generally shown and an input battery source is identified at 226 for supplying power to the module.

A fuse panel 228 is fed inputs accounting for a fuse panel brake switch 230 and turn signals 232. Additional inputs to the module include, in the succession illustrated in FIG. 8, a reverse switch 234, headlamp switch 236, 30A fuse 238, ignition switch run 240, 30A fuse panel 242, ground 244, and microprocessor input 246.

The magnetically switched transistor (or hall effect device formerly identified at 220 in FIG. 6) is again illustrated schematically at 248 and connects, via line 250, to a line 252 extending from the fuse panel 242. The transistor/hall effect device 248 is also connected to ground 244 via line 254 and to the microprocessor input 246 via line 256. The hall effect device 248 operates, through instruction received by the microprocessor 244 and which in turn determines the transition state of the device relative to the position of the magnet 222 (FIG. 6), in order to selectively enable or disable a ground connection, see at 257, associated with the four way and seven way connectors and to thereby power or de-power the connectors.

A series of switches are arranged within the module and include those at 258 (four way and seven way left hand turn signal), 260 (four way and seven way right hand turn signal), 262 (trailer back up lamps), 264 (four way and seven way trailer tail marker lamps), and 266 (seven way trailer battery charge). A trailer brake associated with the seven way connector is illustrated at 268 and completes the schematic illustration of FIG. 8.

Referring now to FIG. 9, an end view is illustrated generally at 270 of the pin connections associated with the four way connector portion and includes, in succession, trailer ground male bullet terminal 272, side marker/tail light/license clearance/I.D. lamp female bullet terminal 274, left turn/stop/hazard lamp female bullet terminal 276 and right turn/stop/hazard lamp female bullet terminal 278. FIG. 10 illustrates, generally at 280, an end view of the pin connections associated with the seven way connector portion and which includes trailer battery charge 282, right turn/hazard lamp 284, trailer back up lamp 286, trailer brake 288, trailer ground 290, left turn/stop/hazard lamp 292, and side marker/tail light/clearance/I.D. lamp 294.

Referring finally to FIG. 7, a yet further variant of the intelligent trailer tow module is illustrated at 296. The module is largely similar to that previously illustrated at 204 in FIG. 6, with the exception that it incorporates a revised access cover 298 with a further portion 300 integrally formed therewith and adapted to cover both the seven way and four way connector portions. This is in contrast to the cover design 208 in FIG. 6 which only overlays the seven way connector in the closed position.

As previously explained, other and additional features which may be incorporated in the smart trailer tow module package include the incorporation of all the rear lighting functions associated with the vehicle, as well as the incorporation of a multiplex node in order to reduce the number of signal wires required between the vehicle and the trailer tow module. Yet additional features include the provision of rear video and weather sensing devices which further operate to monitor temperature and humidity to warn the driver of potential icy road conditions.

Having described the presently preferred embodiments, it is to be understood that the invention may be otherwise embodied within the scope of the appended claims.

What is claimed is:

1. A combined four way and seven way connector assembly for communicating a towing vehicle's electrical system with either a four way or seven way input harness associated with a towed vehicle, the towing vehicle further including a wire harness supplying an output of the electrical system, said connector assembly comprising:
a housing containing a plurality of electrical circuits which communicate with a first plurality of terminals defining a four way connector and a second plurality of terminals defining a seven way connector, each of said first and second pluralities of terminals defining an input plug in said housing and which is accessible by the towed vehicle input harness;
connecting means for electrically communicating the towing vehicle's electrical supply wire harness to said plurality of circuits; and
a monitoring circuit, in operative communication with said four way and seven way connectors, and operative, in response to determining the existence of an attached vehicle input harness, to selectively enable and disable power to said assembly.

2. The connector assembly as described in claim 1, said monitoring circuit further comprising a magnetically switching transistor mounted to said housing and in proximity to an access cover pivotally associated with at least one of said seven way and four way connectors, a magnet attaching to a lip of said cover and, upon pivotally opening said cover, said magnet displacing a distance from said transistor to convert said transistor to an enabled/powered state.

3. The connector assembly as described in claim 2, further comprising said access cover overlaying said seven way connector.

4. The connector assembly as described in claim 2, further comprising said access cover overlaying both said four way and said seven way connectors.

5. The connector assembly as described in claim 1, further comprising at least one back up assist sensor mounted to a rearward facing surface of said housing, said sensors being operatively connected to a processor and, responsive to the detection of an object in the path of a vehicle engaged in reverse gear, signaling an alarm to a driver of the vehicle.

6. The connector assembly as described in claim 1, said plurality of electrical circuits further comprising a printed circuit board.

7. The connector assembly as described in claim 6, said first plurality of terminals including a first plurality of metal frets and said second plurality of terminals including a second plurality of metal frets, an insulating layer interposing between said frets and said circuit board and each of said frets further including interiorly configured receiving holes and extending solder tails which mate and are soldered to said circuit board.

8. The connector assembly as described in claim 1, said plurality of electrical circuits further comprising a common subplurality of four circuits associated with said four way connector, an additional plurality of three circuits combining with said subplurality of four circuits and associated with said seven way connector.

9. The connector assembly as described in claim 6, said circuit board further comprising a plurality of electrical components selected from the group including fuses and mechanical relays, said relays providing power switching functions to said connector assembly.

10. The connector assembly as described in claim 6, further comprising said first and second pluralities of terminals integrally being formed with and extending from a selected face of said printed circuit board.

11. The connector assembly as described in claim 6, further comprising said printed circuit board being encapsulated in a potting material.

12. The connector assembly as described in claim 11, said housing further comprising a first body portion having a top and four interconnected sides, at least one access cover associating with an exterior face of said body portion and being actuable to reveal said first and second pluralities of terminals, a second insulated and backing portion matingly assembling against and open rear of said first body portion and enclosing said circuit board therebetween.

13. The connector assembly as described in claim 12, said connecting means further comprising an annular and inwardly facing wall defined in said second backing portion and which defines an aperture for receiving a plurality of input wires associated with the vehicle electrical supply.

14. The connector assembly as described in claim 1, said plurality of electrical circuits further comprising an insert molded component integrating metal stampings and a plasticized insulator.

15. The connector assembly as described in claim 14, further comprising a plurality of electrical components selected from the group including fuses and mechanical relays and which are assembled upon said insert molded component.

16. The connector assembly as described in claim 15, said housing further comprising a first covering portion having a substantially planar top and four interconnected sides, a second assembly portion including interiorly configured apertures for receiving an insert component defining said first and second pluralities of terminals.

17. The connector assembly as described in claim 16, at least one access cover associating with a face of said second assembly portion opposite said first covering portion, said access cover being actuable to reveal said first and second pluralities of terminals, said second assembly portion securing said first and second pluralities of terminals.

18. The connector assembly as described in claim 17, said connecting means further comprising a plurality of input wires associated with said vehicle electrical supply harness extending through an aperture configured in a selected one of said four interconnecting sides of said first covering portion, extending ends of said input wires engaging selected locations of said insert molded component.

19. The connector assembly as described in claim 1, said plurality of electrical circuits further comprising a flexible circuit having a first face and a second opposite face and which integrates an electrically conductive foil and a plastic insulating laminate.

20. The connector assembly as described in claim 19, said flexible circuit being configured in a desired fashion and so that said first face defines a first location to which are secured said first and second pluralities of terminals, additional pluralities of circuit protection components and relays being secured to at least one additional location of said flexible circuit defined along said first face.

21. The connector assembly as described in claim 20, said housing further comprising a body portion having a top and four interconnected sides enclosing said flexible circuit, at least one access cover associating with an exterior face of said body portion and being actuable to reveal said first and second pluralities of terminals.

22. The connector assembly as described in claim 21, said connecting means further comprising a plurality of input wires associated with said vehicle electrical supply harness and which engage selected locations along said second opposite face of said flexible circuit.

23. A combined four way and seven way connector assembly for communicating a towing vehicle's electrical system with either a four way or seven way input harness associated with a towed vehicle, the towing vehicle further including a wire harness supplying an output of the electrical system, said connector assembly comprising:
a three dimensional housing including a top and a plurality of interconnected sides;
a circuit board supporting a plurality of electrical circuits and which is contained within said housing;
a first plurality of terminals defining a four way connector and a second plurality of terminals defining a seven way connector, each of said first and second pluralities of terminals including metal frets and which communicate with a selected number of said plurality of circuits, said first and second pluralities of terminals defining first and second input plugs accessible through said housing by the towed vehicle input harness;
an integral input connector accessible through said housing and with said circuit board, said input connector electrically communicating the towing vehicle's electrical supply wire harness to said plurality of circuits; and
a monitoring circuit, in operative communication with said four way and seven way connectors, and operative, in response to determining the existence of an attached vehicle input harness, to selectively enable and disable power to said assembly.

24. A combined four way and seven way connector assembly for communicating a towing vehicle's electrical system with either a four way or seven way input harness associated with a towed vehicle, the towing vehicle further including a wire harness supplying an output of the electrical system, said connector assembly comprising:
a three dimensional housing including a top and a plurality of interconnected sides;
a substantially planar shaped component supporting a plurality of electrical circuits and which is contained within said housing;
a first plurality of terminals defining a four way connector and a second plurality of terminals defining a seven way connector, each of said first and second pluralities of terminals communicating with a selected number of said plurality of circuits associated with said planar shaped component, said first and second pluralities of terminals defining first and second input plugs accessible through said housing by the towed vehicle input harness;
connecting means including a plurality of input wires associated with the vehicle electrical supply and which are accessible through said housing and with said circuits contained within said planar shaped component, said input wires electrically communicating the towing vehicle's electrical supply wire harness to said plurality of circuits; and
a monitoring circuit incorporating a magnet and a spatially displacing magnetically switching transistor, in operative communication with said four way and seven way connectors, and operative, in response to determining the existence of an attached vehicle input harness, to selectively enable and disable power to said assembly.
